(19) United States
(12) Patent Application Publication
(10) Pub. No.: US 2013/0088521 A1
(43) Pub. Date: Apr. 11, 2013

(54) ELECTRONIC APPARATUS AND PROGRAM WHICH CAN CONTROL DISPLAY IN ACCORDANCE WITH A USER OPERATION

(71) Applicant: Casio Computer Co., Ltd., Tokyo (JP)

(72) Inventor: Hajime KATOU, Tokyo (JP)

(73) Assignee: CASIO COMPUTER CO., LTD., Tokyo (JP)

(21) Appl. No.: 13/647,751

(22) Filed: Oct. 9, 2012

(30) Foreign Application Priority Data
Oct. 7, 2011 (JP) 2011-222495
Jun. 29, 2012 (JP) 2012-147014

(51) Int. Cl. G09G 5/34; G06F 3/03; G06F 3/041

(52) U.S. Cl. CPC G09G 5/34; G06F 3/041; G06F 3/0304
USPC 345/684; 345/173; 345/158

(57) ABSTRACT

An electronic apparatus for scrolling a display data includes: a first operation detecting section for detecting a first operation indicating a scrolling action of the display data; a scrolling section for scrolling the display data in a scrolling direction corresponding to the first operation; a second operation detecting section for detecting a second operation which controls the scrolling action indicated by the first operation after detecting the first operation; and a scroll controlling section for performing a scrolling backward action for a predetermined amount and stopping the scrolling backward action when the second operation is detected by the second operation detecting section.

### CROSS-REFERENCE TO RELATED APPLICATION

This application is based upon and claims the benefit of priority under 35 USC 119 of Japanese Patent Application No. 2011-222495 filed on Oct. 7, 2011 and Japanese Patent Application No. 2012-147014 filed on Jun. 29, 2012, the entire contents of which are incorporated herein by references.

### BACKGROUND OF THE INVENTION

1. Field of the Invention

The present invention relates to an electronic apparatus and program which can control a display content in accordance with a user operation.

2. Description of the Related Art

In recent years, printers are provided which can print an address and text on a postcard for domestic use. With such a printer, for example, an address and text on a postcard can easily be printed at home.

And some of these printers have an edit function which can edit images inputted from a portable record medium without using a personal computer.

With such a printer, for example, a photograph taken with a digital still camera (DSC) can easily be edited for printing directly by the printer without involving a personal computer, and therefore, the printer is now becoming a very useful tool for users who have no personal computer. Additionally, in this situation that image data stored within the DSC or in an exterior recording medium is stored in the printer, the stored images can be printed selectively. Thus, the printer is also useful in this respect.

In recent years, printers are well known whose operation performance is improved in making/editing document and selecting image data by having a touch panel on the printer.

With such a printer having a touch panel, for example, a contents size to be displayed on a display area is limited within a size of a touch panel. Therefore, when displaying contents such as texts or pictures on the display area of the touch panel, a predetermined display process, which displays a whole or part of the contents comprising texts or pictures for one or a couple of pages, is performed.

In addition, with such the printer having a touch panel, for example, when one of a drag manipulation (a sequence manipulation of touch→drag) and flick manipulation (a sequence manipulation of touch→move quickly in any direction→release) that is performed by the user manipulation is detected while only a part of the texts and pictures is displayed on the touch panel, a display process which scrolls the contents in response to the detected manipulation is performed.

However, when the user searches his/her intended part among contents while only a part of the contents is displayed on the touch panel, the user operates the flick manipulation in a forward direction and backward direction repeatedly until the user finds his/her intended part. Because it is difficult for the user to recognize his/her intended part on a scrolling display in response to the flick manipulation and stop the scrolling display at his/her intended part.

This is the reason that this electronic apparatus having the touch panel whose operation performance is improved is desired.

Furthermore, a middle position of a sentence in the contents may be displayed after scrolling the contents on the touch panel display in related to a length of the sentence, a break line position and the flick manipulation. In this situation, it is also difficult for the user to recognize a meaning of the whole sentence and find his/her intended part quickly.

By the way, Japanese Patent Publication No. 2010-9104 (hereinafter, referred to as the “patent document”) discloses a digital book which can easily be browsed in response to a user manipulation on a touch panel.

In the digital book described in the patent document above, a technique, which leads user eyes by displaying cursor in order to prevent that the user misread his/her intended part, is disclosed. However, the patent document does not disclose a technique that finds his/her intended part among contents and displays it quickly by user's flick manipulation.

### SUMMARY OF THE INVENTION

The present invention has been made in view of the foregoing problems of conventional technique.

It is accordingly an object of the present invention to provide an electronic apparatus which a user can easily find his/her intended part in response to a user manipulation even if his/her intended part has been passed.

According to an aspect of the present invention, there is provided an electronic apparatus for scrolling a display data comprising: a first operation detecting section for detecting a first operation indicating a scrolling action of the display data; a scrolling section for scrolling the display data in a scrolling direction corresponding to the first operation; a second operation detecting section for detecting a second operation which controls the scrolling action indicated by the first operation after detecting the first operation; and a scroll controlling section for performing a scrolling backward action for a predetermined amount and stopping the scrolling backward action when the second operation is detected by the second operation detecting section.

According to another aspect of the present invention, there is provided an electronic apparatus comprising for switching a plurality of display data to be displayed sequentially every predetermined time; a first operation detecting section for detecting a first operation indicating a switching action of the display data in a switching direction; a second operation detecting section for detecting a second operation which controls the switching action indicated by the first operation after detecting the first operation; and a switch controlling section for performing a switching backward action for a predetermined time and stopping the switching backward action when the second operation is detected by the second operation detecting section.

### BRIEF DESCRIPTION OF THE DRAWING

FIG. 1 is a perspective view of an electronic apparatus according to an embodiment of the invention.

FIG. 2 is an exemplary sectional view of the electronic apparatus of the embodiment of the invention.

FIG. 3 is an explanatory diagram showing a keyboard of the electronic apparatus according to the embodiment of the invention.

FIG. 4 is a functional block diagram of the electronic apparatus according to the embodiment of the invention.

FIG. 5 is an explanatory diagram showing an example of contents comprising texts to be processed by the electronic apparatus according to the embodiment of the invention.

FIGS. 6A-6D are explanatory diagrams showing an example of a display content when editing the contents according to the embodiment of the invention.

FIG. 7 is a flowchart showing the entire flow performed by the electronic apparatus according to the embodiment of the invention.

FIG. 8 is a flowchart showing the flow of a scrolling process corresponding to a flick process performed by the electronic apparatus according to the embodiment of the invention.

FIG. 9 is a flowchart showing the flow of an interrupting process during the scrolling process performed by the electronic apparatus according to the embodiment of the invention.

FIG. 10 is a flowchart showing the flow of another scrolling process corresponding to the flick process.

FIG. 11 is a functional block diagram of a projector applied as the electronic apparatus according to the embodiment of the invention.

FIGS. 12A-12C are explanatory diagrams showing a gesture operation performed in front of the image capturing section 1012.

FIG. 13 is a flowchart showing the flow of a scrolling process performed by the projector.

FIG. 14 is a flowchart showing a continuation flow of the flow shown in FIG. 13.

FIG. 15 is a functional block diagram of a smartphone applied as the electronic apparatus according to the embodiment of the invention.

FIGS. 16A-16B are explanatory diagrams showing directions of a flick manipulation on the touch display 1026 and an image switching process during the slide show.

FIG. 17 is a flowchart showing the flow of a switching process performed by the smartphone.

### DETAILED DESCRIPTION OF THE PREFERRED EMBODIMENTS

### First Embodiment

Hereinafter, the first embodiment of the invention will be described by reference to the drawings. The invention relates to an electronic apparatus 1 which can display contents comprising texts and images to be edited on a touch panel and print the prepared contents on post cards.

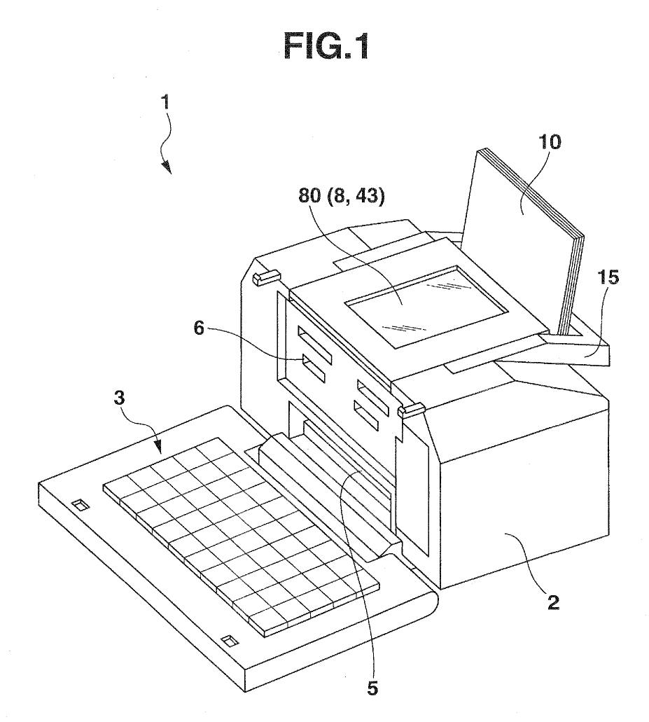

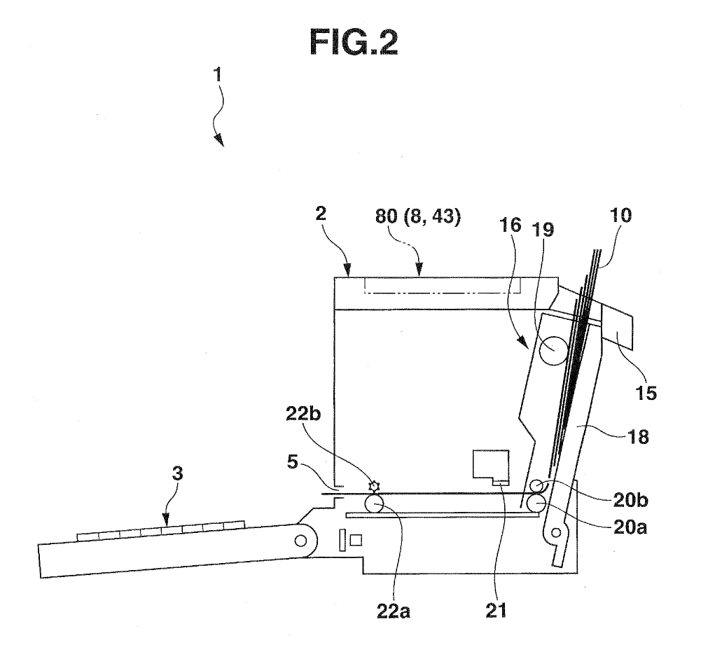

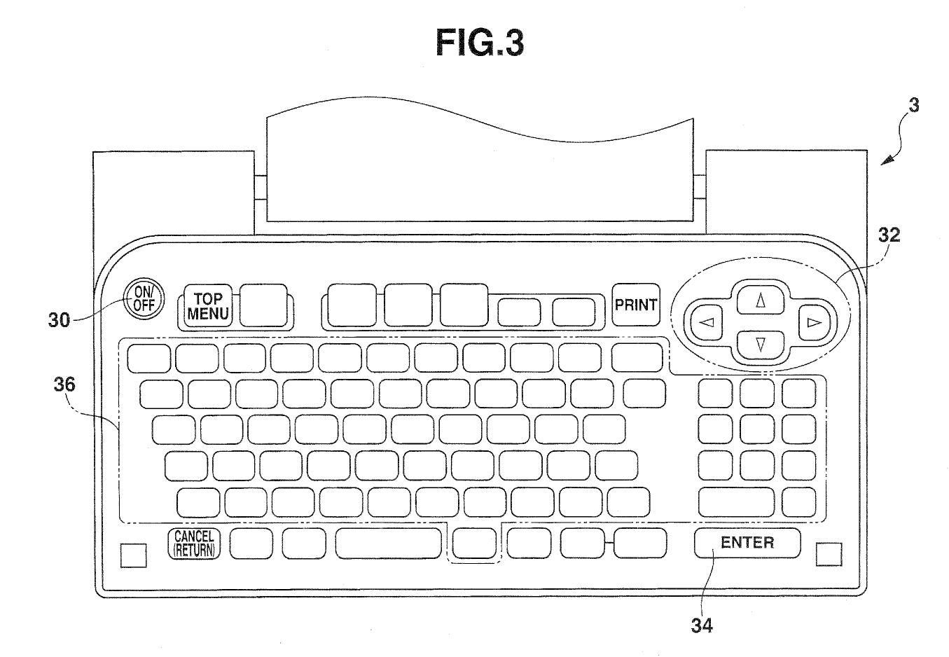

FIG. 1 is a perspective view showing an external appearance of the electronic apparatus 1, FIG. 2 is an exemplary side sectional view of the electronic apparatus 1, and FIG. 3 is an explanatory diagram showing a keyboard 3 of the electronic apparatus 1. In FIG. 2, hatching is not given for the sake of easy understanding of what is shown in the diagram.

The electronic apparatus 1 is an apparatus for printing information on relatively small printing sheets 10 such as post cards (100′148 mm), L-size sheets (89′127 mm) and 2L-size sheets (178′127 mm). The image printer 1 has various functions including a function to prepare an address book, a function to automatically write an address to post cards directly from the address book, a function to capture a photographic image and print it as a photograph, a function to edit texts and a function to combine the captured image and the edited text and print them on post cards.

As shown in FIGS. 1 and 2, this electronic apparatus 1 includes a box-shaped casing 2, and a keyboard 3 as an input unit is disposed in front of the casing 2. This keyboard 3 is installed rotatably near a front lower end of the casing 2. When in use, the keyboard 3 is unfolded flat to expand to the front of the casing 2 as shown in FIG. 1, while when not in use, the keyboard 3 is folded up to face a front side of the casing 2 for stowage.

As shown in FIG. 3, disposed on the keyboard 3 are a power on/off switch key 30 used to switch on and off a power supply, cursor keys 32 used to select items and change settings of the items selected, an enter key 34 used to determine on selections and changes made to progress the operation, a top menu key used to cause a top menu screen to be displayed on a liquid crystal display 8, a print key used to instruct an execution of printing, and character and numeral keys 36 used to input characters and numbers.

Each key functions as an input device to transmit a predetermined operation signal based on an input operation performed by the user to a CPU 41 as described hereinafter.

A sheet discharge port 5 and a storage medium insertion port 6 are formed in a front side of the casing 2 as shown in FIG. 1. Printing sheets 10 such as post cards or photographic papers on which printing is completed are discharged from the sheet discharge port 5, and a portable storage medium such as a memory card can be inserted into the storage medium insertion port 6. By inserting a detachable portable storage medium such as a memory card into the storage medium insertion port 6, image data of photographs taken by a digital camera, edited data such as texts which are edited on a personal computer and addressee data of an address book which includes names and addresses of a plurality of addressees can be taken into the electronic apparatus 1, and on the contrary, data which are edited on the electronic apparatus 1 can be preserved in the memory card inserted.

A liquid crystal display with touch panel 80 which combines the liquid crystal display 8 and a touch panel 43 is disposed on an upper side of the casing 2 as a display, and this liquid crystal display with touch panel 80 can be turned in the direction of the front side of the casing 2. Various types of data required on the electronic apparatus 1 is displayed on the liquid crystal display 8, and the various types of data include input details which are displayed on a screen in association with input signals from the keyboard 3, a menu screen required for various types of settings, and photographic images captured from the digital camera for display thereon. This liquid crystal display 8 may be configured as an organic EL display from time to time.

Further, a handle 15 is mounted on an upper portion of the casing 2 so as to rotate from the rear of the casing 2 to a position lying above the casing 2. This handle 15 has a substantially U-shape and is grabbed by the user for him or her to carry the electronic apparatus 1.

As shown in FIG. 2, the casing 2 has a space portion 16 which is opened to a back side thereof, and a sheet feeding tray 18 is disposed so as to close the opening in the space portion 16. The sheet feeding tray 18 is pivotally mounted at the rear of the casing 2 in a position lying near a lower end thereof. The sheet feeding tray 18 can be rotated so that an upper end thereof moves in a front-to-rear direction and accommodate a plurality of printing sheets 10 in a pile.

A pick-up roller 19 is disposed in an upper position inside the sheet feeding tray 18, and printing sheets 10 accommodated in the sheet feeding tray 18 are fed downwards sheet by sheet by the pick-up roller 19. Delivery rollers 20a, 20b are disposed near a lower end of the sheet feeding tray 18 for delivering the printing sheet 10 fed downwards by the pick-up roller 19 in the direction of the sheet discharge port 5 of the casing 2. Further, a printing head 21, which is a printing section 55, is disposed in an interior of the casing 2 in a position lying in front of and near the delivery rollers 20a, 20b. Additionally, discharge rollers 22a, 22b are disposed in the interior of the casing 2 in a position lying to the front of the printing head 21 for discharging the printing sheet 10 on which printing is completed from the sheet discharge port 5. The delivery roller 20a and the discharge roller 22a are controlled to rotate by stepping motors, not shown, so as to deliver a printing sheet 10 at a predetermined speed. The pick-up roller 19, the delivery rollers 20a, 20b, and the discharge rollers 22a, 22b function as a conveying section 56 of the electronic apparatus 1.

The printing head 21, which is the printing mechanism, is an inkjet type printing head 21 which has nozzles which jet individually inks of yellow (Y), magenta (M) and cyan (C) colors. The printing head 21 executes printing by jetting the inks of the respective colors to a printing sheet 10. Although the printing head 21 is described as being the inkjet type printing head 21, the invention is not limited to the inkjet type printing head.

Then, the printing sheets 10 accommodated in the sheet feeding tray 18 are sequentially fed downwards by the pick-up roller 19, starting from a printing sheet 10 positioned on a top or front of the pile. Then, the printing sheet 10 is fed out below the printing head 21 while the printing sheet 10 being held between the delivery rollers 20a, 20b. When printing thereon is completed, the printing sheet 10 is fed forwards to be inserted between the discharge rollers 22a, 22b so as to be discharged to the outside of the electronic apparatus 1 from the sheet discharge port 5.

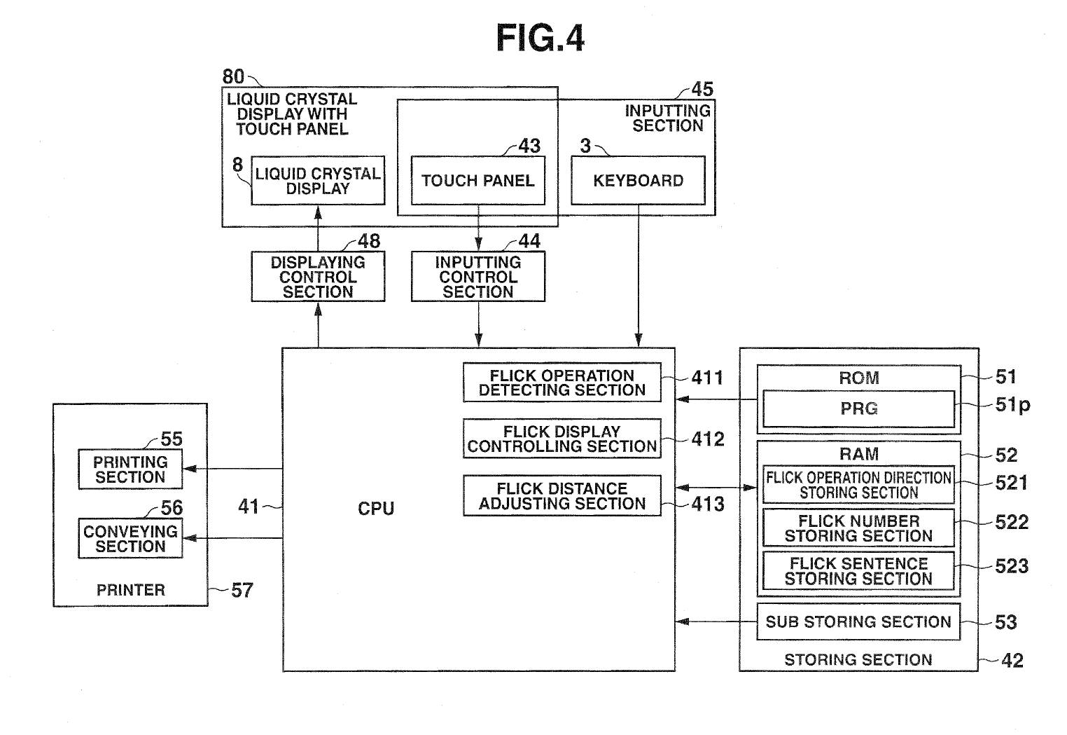

Next, a CPU 41 of the electronic apparatus 1 of the embodiment will be described. FIG. 4 is a functional block diagram of the electronic apparatus 1. As shown in FIG. 4, the electronic apparatus 1 includes the CPU 41 which governs the whole of the system, a storing section 42 made up of a ROM 51, a RAM 52 and a sub storing section 53 comprising removable storage medium such as a memory card, the liquid crystal display 8, a displaying control section 48 which controls the liquid crystal display 8, an input unit 45 comprising the touch panel 43 and the keyboard 3, an inputting control section 44 which controls the touch panel 43, a printer 57 and a speaker which is not shown in Figs.

The liquid crystal display 8 is controlled by the CPU 41 received a predetermined operation signal and displays a predetermined display via the displaying control section 48.

The keyboard 3 described above is made up of the power on/off switch key 30, the cursor keys 32, enter key 34 and the print key.

The touch panel 43 having an operation interface is a sensor which detects, a state that an operation object such as fingers touches on the operation interface of the touch panel 43 and a touch position of the operation object, and outputs corresponding signals of the touch position. The touch panel 43 may be used as capacitance type or resistive type touch panel. The touch panel 43 may be a multi-tap touch panel which can detect plural positions of the operation object.

The inputting control section 44 detects, the touch position touched by the operation object such as fingers on the operation interface of the touch panel 43 based on the signals inputted from the touch panel 43, and outputs the signals indicating the touch position and state to the CPU 41.

For details, the inputting control section 44 outputs signals, indicating x-coordinate and y-coordinate as position information on the operation interface, to the touch panel 43 when detecting the operation object on one position of the operation interface.

And, the inputting control section 44 outputs signals corresponding to detected operation object to the touch panel 43 when detecting the operation object on two positions of the operation interface.

And, the inputting control section 44 detects, a moving direction and a moving speed of the operation object based on an alteration of the signals corresponding to the touch position on the operation interface from moment to moment, and outputs the signals indicating the moving direction and the moving speed to the CPU 41.

In the foregoing embodiment, a description has been given using the inputting control section 44, the displaying control section 48 and the CPU 41. However, the present invention is not limited to this but can equally be applied to the inputting control section 44 and the displaying control section 48 without the touch panel. In this case, the CPU 41 performs a predetermined program which can perform a function of the touch panel.

The CPU 41 activates a system program pre-stored in the ROM 51, or a control program stored in the memory card in response to a key operation signal from the inputting section 45 or automatically so as to control operations of respective circuit portions by use of the RAM 52 as a work memory.

Stored in the ROM 51 are fonts used in editing texts and printing type faces, information on standards of printing papers to be edited, a program 51p, and control programs used when the CPU 41 controls the various constituent units.

The RAM 52 is the work memory which stores information used in editing a text such as characters inputted at the inputting section 45, display data which is displayed on the liquid crystal display 8, variables and registers which are used in arithmetic operation, and image information during image processing.

And, the RAM 52 is made up of a flick operation direction storing section 521, a flick number storing section 522, a flick sentence storing section 523 and a position storing area which stores the position information of the operation object detected on the touch panel 43.

The flick operation direction storing section 521 stores a flick direction of the flick operation detected on the touch panel 43.

The flick number storing section 522 stores a number of the flick operation operated in the same direction on the touch panel 43.

The flick sentence storing section 523 stores a position of a sentence operated the flick operation at the beginning of the flick operation when a part of the contents is displayed on the liquid crystal display 8.

Data of an image such as the photographic image taken by the digital camera, the scanned image, texts, addresses, or names of address which is stored in the sub storing section 53 can be read by the CPU 41. A predetermined data is written in the sub storing section 53 by the CPU 41.

The printer 57 is made up of the printing section 55 and the conveying section 56. The printing section 55 is made up of the printing head 21 described above and executes printing on a printing sheet 10.

The conveying section 56 is made up of the stepping motors which rotate the pick-up roller 19, the delivery rollers 20a, 20b and the discharge rollers 22a, 22b and delivers a printing sheet 10.

In this embodiment, the CPU 41 detects an operation of the operation object based on the signals detected on the touch panel 43. A sort of the operation of the operation object may become “touch operation”, “release operation”, “drag operation”, “flick operation” and “tap operation”.

The touch operation is an operation that the operation object such as user's finger is touched on the operation interface of the touch panel 43.

The release operation is an operation that the operation object such as user's finger is released from the operation interface of the touch panel 43.

The drag operation is an operation that the operation object such as user's finger is dragged while the user's finger keeps touching on the operation interface of the touch panel 43.

The flick operation is an operation that the above operations are performed in the order of the touch operation→the drag operation→the release operation sequentially within a predetermined time such as 0.5 seconds.

The tap operation is an operation that the operation object such as user's finger is tapped on the operation interface of the touch panel 43 once or more within a predetermined time such as 0.2 seconds.

The CPU 41 receives the signals from the inputting control section 44 and performs as a flick operation detecting section 411 which detects the flick operation described above based on an alteration of the signals corresponding to the touch position of an operation object 90 on the operation interface from moment to moment.

When a first flick operation is detected once in a predetermined direction, the CPU 41 performs as a flick display controlling section 412 which scrolls a part of the contents displayed on the liquid crystal display 8 in the predetermined direction corresponding to the first flick operation in increments of one block to be a first moving amount defined by a width of the liquid crystal display 8 in the predetermined direction.

Briefly, the CPU 41 moves a display area of the liquid crystal display 8 in a backward direction against the predetermined direction.

Further, when a second flick operation in a backward direction against the predetermined direction is detected by the flick operation detecting section 411 during the first scrolling process described above or a predetermined time after stopping the first scrolling process, the CPU 41 performs as a flick distance adjusting section 413 which adjusts a second moving amount scrolled by the second flick operation from the one block as the first moving amount to half block which is smaller than the first moving amount.

In this embodiment, the first moving amount is not limited to the width of the liquid crystal display 8. In this case, all the second moving amount need is to be smaller than the first moving amount.

In addition, when a double tap operation is detected on the touch panel 43, the CPU 41 controls the displaying control section 48 such that a part of the contents such as texts and images is enlarged on the liquid crystal display 8 based on that double tap operation.

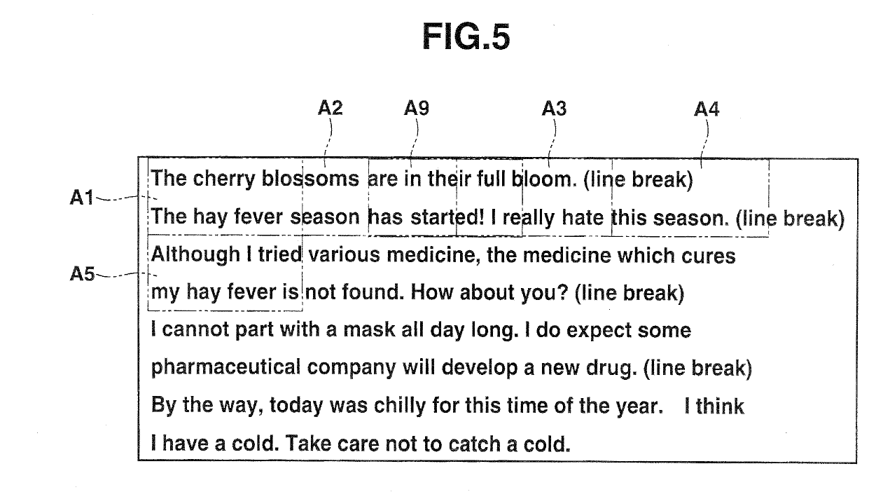

Next, preferred performances of the CPU 41 when editing the contents will now be described with reference to the drawings. FIG. 5 is an explanatory diagram showing an example of contents comprising texts to be processed by the electronic apparatus according to the embodiment of the invention.

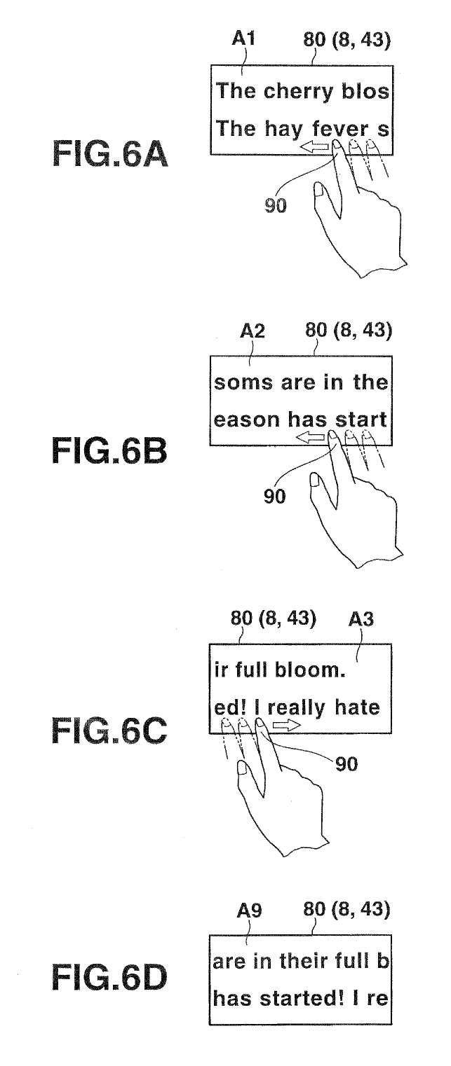

FIGS. 6A-6D are explanatory diagrams showing an example of a display content when editing the contents according to the embodiment of the invention.

In the embodiment, the CPU 41 generates the contents including documents described in FIG. 5 and stores the contents in the storing section 42 in response to an inputting operation via the keyboard 3 and the touch panel 43.

A part of the contents described in FIG. 5 comprise a plurality of texts. In details, the texts described in FIG. 5 are defined in a predetermined number of characters for one line, such as 29 characters. The texts described in FIG. 5 have break line codes at a predetermined position.

Next, preferred performances of the CPU 41, performed when the user operates the liquid crystal display with touch panel 80 so as to find an intended part in the documents such as an editing point, will be described.

For example, when editing the texts, the user performs the double tap operation on the liquid crystal display with touch panel 80 by the operation object such as the user's finger and indicates to enlarge a part of the texts described in FIG. 6A.

In details, the CPU 41, when the double tap operation is detected on the operation interface while the texts is being displayed on the liquid crystal display with touch panel 80 described in FIG. 5, executes a process that displays an image A1 which a part of the texts are enlarged on the liquid crystal display 8 described in FIG. 6A.

The CPU 41 executes a process that displays the texts stored in the storing section 42 on the liquid crystal display 8 in increments of the one block corresponding to the displayable area of the liquid crystal display 8.

The CPU 41, when the drag operation is detected in the predetermined direction on the operation interface while the image A1 is being displayed on the liquid crystal display 8 described in FIG. 6A, executes a process that scrolls the part of the contents on the liquid crystal display 8 with a speed corresponding to the drag operation.

That is, the CPU 41 performs a process that moves the display area of the liquid crystal display 8 in a backward direction against the predetermined direction.

And, the CPU 41, when the first flick operation is detected once in the predetermined direction which is a direction from right to left on the operation interface while the image A1 is displayed on the liquid crystal display 8 described in FIG. 6A, executes a process that scrolls the part of the contents displayed on the liquid crystal display 8 with a high speed corresponding to the first flick operation, decreases the first scrolling process gradually and stops.

The image A2 described in FIG. 6B indicates the display area that is moved from the display area of the image A1 to right for the first moving amount according to the width of the liquid crystal display 8 in horizontal direction.

Further, when the CPU 41 detects the flick operations more than once in the same direction sequentially, the CPU 41 defines a scrolling time, such as about 0.2 seconds, while the part of the contents is scrolled corresponding to the flick operations and a fixing display time, such as about 0.8 seconds, after stopping the scrolling process.

For details, as shown in FIG. 5 and FIG. 6A, the CPU 41, when the flick operations is detected more than once in the same direction sequentially while the image A1 is being displayed on the liquid crystal display 8, executes a process that, first scrolls the part of the contents on the liquid crystal display 8 with a high speed for about 0.2 seconds, secondly stops the scrolling process and fixes the display for about 0.8 seconds, then scrolls again for about 0.2 seconds and stops it for 0.8 seconds.

In this way, when the flick operations is detected more than once in the same direction sequentially, it becomes that the user can easily find his/her intended part in the documents by repeating the scrolling process and fixing the display.

Also, the fixing display time is defined being easy to read for the user based on such as a number or a size of the characters displayed in the liquid crystal display 8.

If new flick operation is not detected after fixing the display, the CPU 41 keeps fixing the display.

And, the CPU 41 stores the number of the flick operations performed in the same direction in the flick number storing section 522 and subtracts the number every time to complete the scrolling process. In other words, the CPU 41 performs the scrolling process and the fixing display process repeatedly until the number of the flick operations becomes 0.

For details, when the flick operations is detected twice in a direction to the left sequentially while the image A1 is being displayed on the liquid crystal display 8 described in FIG. 5 and FIG. 6A, the CPU 41 executes a process that displays the image A2 and A3 described in FIGS. 6B and 6C through the scrolling process and the fixing display process sequentially.

Then, when the CPU 41 detects the second flick operation in the backward direction which is a direction from left to right during the first scrolling process or within a predetermined time such as 1 second after stopping the first scrolling process, the CPU 41 executes a process that scrolls the part of the contents backward displayed on the liquid crystal display 8 for the second moving amount which is smaller than the first moving amount.

For details, when the CPU 41 detects the second flick operation in right after repeating the first scrolling process to left described in FIGS. 6A-6C, the CPU 41 executes a process that scrolls the part of the contents displayed on the liquid crystal display 8 for the second moving amount which is smaller than the first moving amount in the backward direction and displays the image A9 described in FIG. 5 and FIG. 6D.

Thus, the second moving amount is usually set as a smaller amount than the first moving amount.

However, when the CPU 41 detects the second flick operation in right after the predetermined time such as 1 second after stopping the first scrolling process, the CPU 41 executes a process that scrolls the part of the contents on the liquid crystal display 8 for not the second moving amount but the first moving amount in the backward direction.

The image A9 described in FIG. 6D shows the part of the contents that locates to the image A3's left for half block.

In this way, the CPU 41 can executes a process that displays his/her intended part of the contents quickly and easily on the liquid crystal display 8 in response to the flick operations because the second moving amount of the contents is set as a smaller amount than the first moving amount when the part of the contents scrolls in the backward direction in response to the second operation.

In addition, when detecting the first flick operation in the predetermined direction in a display area scrolled for half block, the CPU 41 executes a process that scrolls the part of the contents for the first moving amount based on the display area scrolled for half block.

As a result, it becomes the user can easily find his/her intended part of the contents by displaying various area of the contents on the liquid crystal display 8.

Further, the CPU 41 detects line breaks and periods in all lines displayed on the liquid crystal display 8. When the first flick operation operated from an end to beginning of the line is detected while the part of the contents which includes at least one of the detected line break or period is displayed on the liquid crystal display 8, the CPU 41 executes a process that displays the next line from the beginning.

For details, when the first flick operation operated from right to left is detected while the image A4 described in FIG. 5 including a line break is displayed on the liquid crystal display 8, the CPU 41 performs to display an image A5 described in FIG. 5 which includes the beginning of next line.

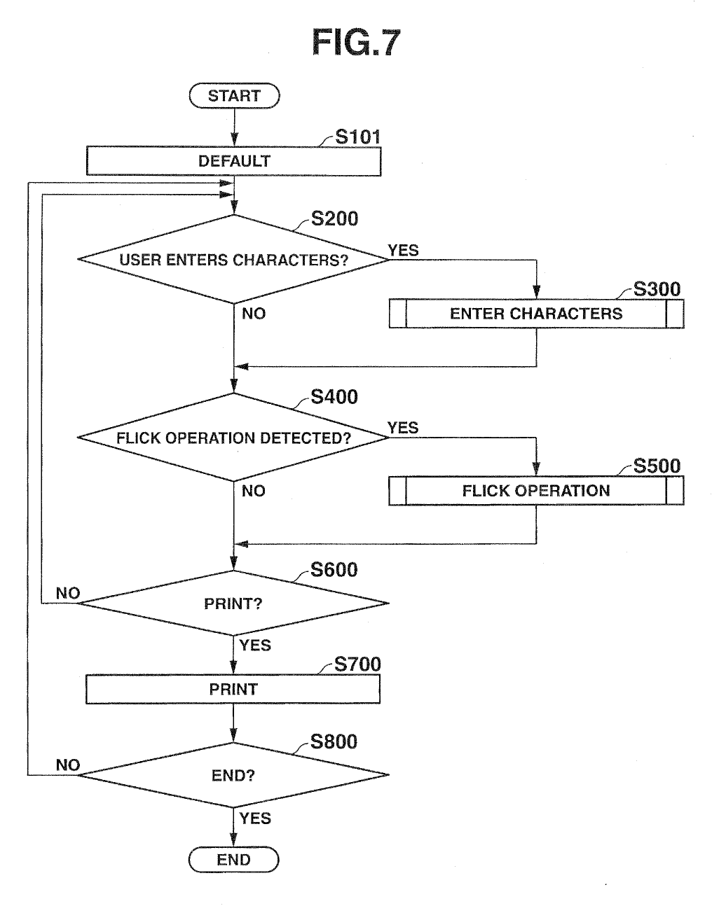

FIG. 7 is a flowchart showing the entire flow performed by the electronic apparatus according to the embodiment of the invention. For details, FIG. 7 explains a performance of the electronic apparatus 1 in response to the flick operation while the user edits the documents.

First, the CPU 41 performs a predetermined default process based on an initial data stored in the ROM 51 and RAM 52 and an operation signals inputted from the inputting section 45.

The CPU 41 defines, such as a print sheet size, number of characters for one line, number of lines and blank space as the default process (step S101).

Next, the CPU 41 reads the documents stored in the storing section 42 and displays so as to be a print layout on the liquid crystal display 8 for editing the documents.

Then, the CPU 41 judges whether a characters inputting process is performed (step S200).

When the CPU 41 judges the characters inputting process is not performed, the flow proceeds to step S400.

When the CPU 41 judges the characters inputting process is performed, the CPU 41 executes the characters inputting process based on the operation inputting signals inputted by the keyboard 3 and the liquid crystal display with touch panel 80 (step S300). After the characters inputting process, the flow proceeds to step S400.

At step S400, the CPU 41 judges whether the first flick operation is performed based on the signals via the touch panel 43 and the inputting control section 44.

When the CPU 41 judges the first flick operation is not performed, the flow proceeds to step S600.

When the CPU 41 judges the first flick operation is performed, the CPU 41 executes a flick process (step S500) described below based on positioning signals of the operation object and proceeds to step S600.

At step S600, the CPU 41 judges whether a printing process is performed based on the operation inputting signals inputted from the keyboard 3 and the liquid crystal display with touch panel 80.

When the CPU 41 judges the printing process is not performed, the flow proceeds back to step S200.

When the CPU 41 judges the printing process is performed, the CPU 41 performs the printing process (step S700).

At step S700, the CPU 41 executes the printing process for the print sheets 10 by controlling the printing section 55 and conveying section 56 of the printer 57.

After the printing process, the flow proceeds to step S800.

Next, at step S800, the CPU 41 judges whether finishing successive processes described above.

For example, the CPU 41 judges whether the power on/off switch key 30 disposed on the keyboard 3 is operated.

When the CPU 41 judges the power on/off switch key 30 is not operated, the flow proceeds back to step S200.

When the CPU 41 judges the power on/off switch key 30 is operated, the CPU shuts down the above successive processes.

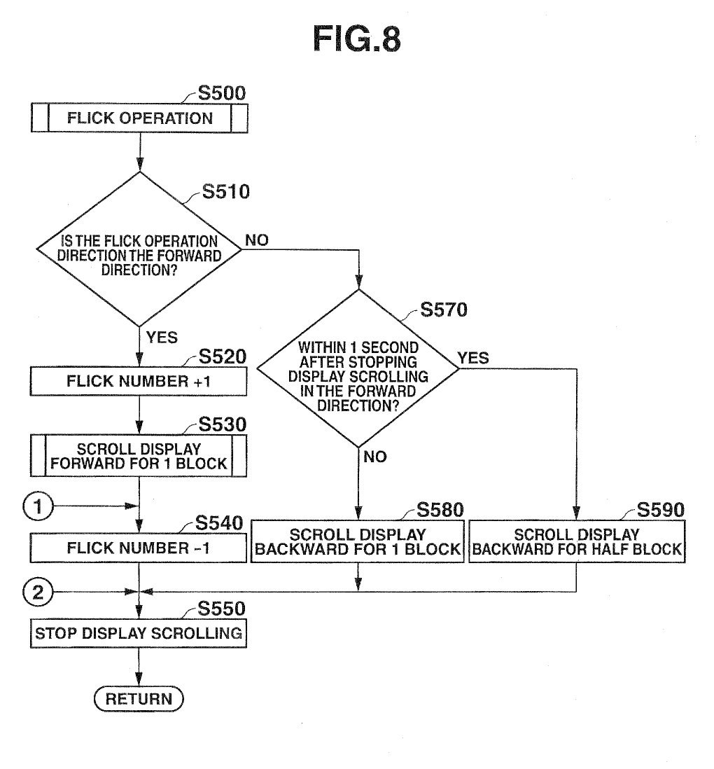

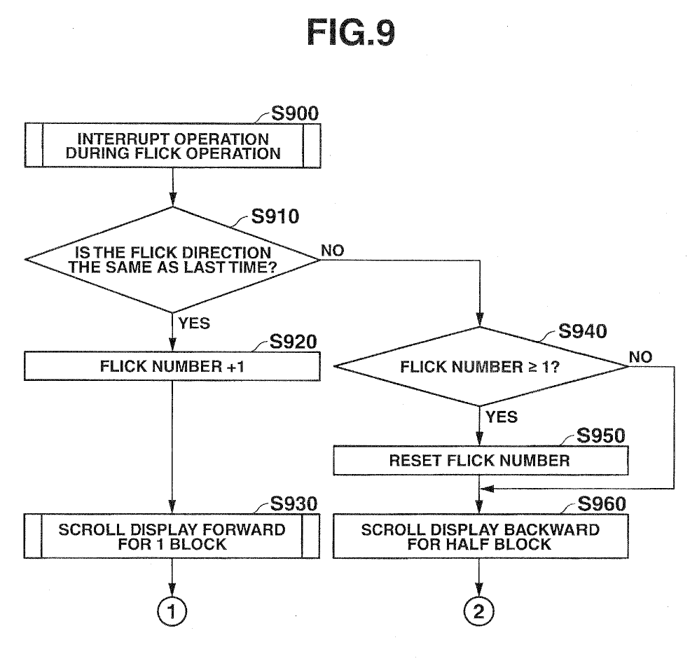

A flow of the flick process (step S500) described in FIG. 7 will be described in detail by referring FIG. 8 and FIG. 9

FIG. 8 is a flowchart showing the flow of a scrolling process corresponding to a flick process performed by the electronic apparatus according to the embodiment of the invention.

First, the CPU 41 judges whether the first flick operation in the predetermined (forward) direction which is horizontal direction from right to left is detected based on an alteration of the signals corresponding to the touch position of the operation object inputted by the touch panel 43 and the inputting control section 44 from moment to moment (step S510).

When the CPU 41 judges the first flick operation in the forward direction is detected, the flow proceeds to step S520, otherwise the flow proceeds to step S570.

Further, the CPU 41 executes an interrupting process (step S900) at all times as a concurrent process during processes performed from step S520 to step S 550.

Then, at step S520, the CPU 41 executes a process that adds 1 on a flick number and stores the flick number in the flick number storing section 522 corresponding to the flick process in step S510.

Following this, the CPU 41 executes the first scrolling process based on the first flick operation detected on the liquid crystal display with touch panel 80 (step S530).

For details, when detecting the first flick operation in the predetermined direction performed by the operation object on the touch panel 43 while the image A1 is displayed on the liquid crystal display 8 described in FIG. 6A, the CPU 41 performs the first scrolling process with high speed based on a flick speed of the first flick operation on the operation interface of the liquid crystal display 8 and reduces the scrolling speed as time advances.

The CPU 41 scrolls the part of the contents for a predetermined time such as 1 second as the first scrolling process.

Next, the CPU 41 executes a process that reduces 1 from the flick numbers stored in the flick number storing section 522 after stopping the first scrolling process corresponding to the first flick operation (step S540).

Further, the CPU 41 executes the fixing display process for a predetermined time such as 0.8 seconds which stops and fixes the scrolling display for a predetermined time (step S550).

Following this, the flow proceeds to step S600 described in FIG. 7.

At step S510, when detecting the second flick operation in the backward direction which is a direction from left to right, the CPU 41 judges whether 1 second has been passed after stopping the first scrolling process (step S570).

When the CPU 41 judges that 1 second has been passed after stopping the first scrolling process; in other words, when detecting the second flick operation after 1 second from the first scrolling process is finished, the CPU 41 executes the second scrolling process which scrolls the part of the contents in the backward direction for one block (step S580). Then, the flow proceeds to step S 550.

At step S570, when the CPU 41 judges that 1 second has not been passed after stopping the first scrolling process; in other words, when detecting the second flick operation within 1 second after the first scrolling process is finished, the CPU 41 executes the second scrolling process which scrolls the part of the contents in the backward direction for half block (step S590). Then, the flow proceeds to step S 550 after the flick number stored in the flick number storing section 522 has been reset to 0.

A flow of the interrupting process (step S900) during the flick process (step S500) described in FIG. 8 will be described in detail by referring FIG. 9.

The CPU 41 executes the interrupting process (step S900) at all times as a concurrent process during step S 530 and step S 550 described in FIG. 8 and FIG. 9.

The CPU 41 does not execute the interrupting process (step S900) at step S580, step S590 described in FIG. 8 and step S960 described in FIG. 9.

First, the CPU 41 judges whether a flick direction of a flick operation is the same direction as the last flick operation of the first flick operation.

When the CPU judges the flick direction of the flick operation is the same direction as the last one, the CPU 41 adds 1 to the flick number and stores it (step S 920). Following this, the CPU 41 finishes the interrupting process after executing the further first scrolling process for one block as well as step S530.

Then the flow proceeds to step S 540 described in FIG. 8.

At step S910, when judging the flick direction of the flick operation is the backward direction as the last one, the CPU 41 judges whether the flick number stored in the flick number storing section 522 exceeds 1 (step S940).

When the CPU 41 judges the flick number stored in the flick number storing section 522 exceeds 1, the CPU 41 resets the flick number stored in the flick number storing section 522 (step S950) and finishes the interrupting process after executing the second scrolling process for half block (step S960) which scrolls the part of the contents in the backward direction for half block which is a smaller than the first moving amount.

Then, the flow proceeds to step S550 described in FIG. 8.

At step S940, when the CPU judges the flick number stored in the flick number storing section 522 does not exceed 1, the flow proceeds to step S 960.

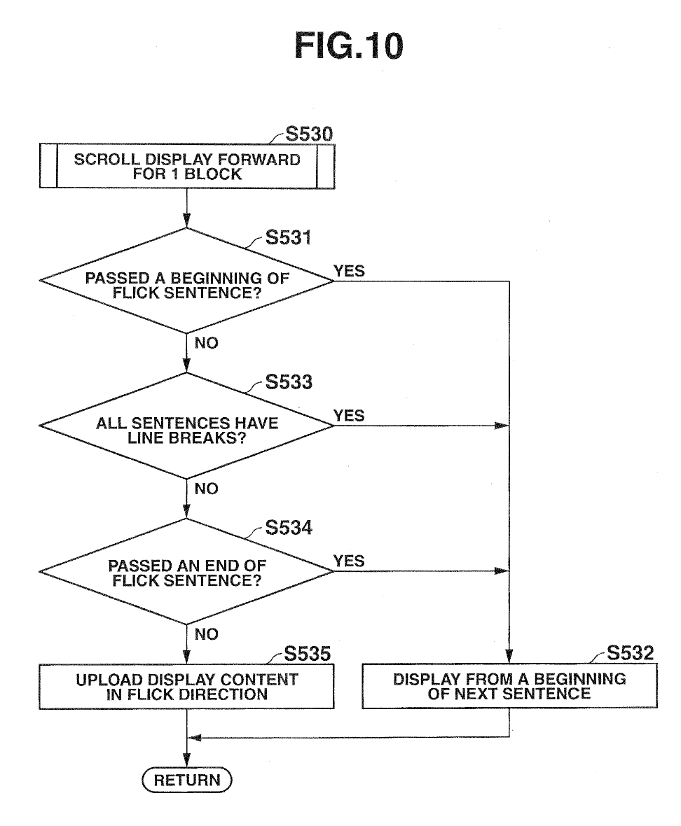

Next, a flow of the first scrolling process (step S530) corresponding to the flick process (step S500) described in FIG. 8 will be described in detail by referring FIG. 10.

The CPU 41 judges whether a beginning of sentence in the contents has been passed on the liquid crystal display 8, during the first scrolling process corresponding to the first flick operation in the predetermined direction, based on line break codes or ends of sentences in the contents displayed on the liquid crystal display 8 (step S531).

When judging the beginning of sentence in the contents has been passed on the liquid crystal display 8 during the first scrolling process, the CPU 41 executes a process that displays a next sentence from the beginning for one block (step S532) and proceeds to step S540 described in FIG. 8. Otherwise, the flow proceeds to step S533.

Next, the CPU 41 judges whether all break line codes of sentences for which the first flick operation is performed have been passed on the liquid crystal display 8 during the first scrolling process in the predetermined direction which is a direction from an end to beginning of sentence for the part of the contents displayed on the liquid crystal display 8 (step S533).

When judging all break line codes of sentences for which the first flick operation is performed have been passed on the liquid crystal display 8, the CPU 41 executes a process that displays a next sentence from the beginning for one block (step S532). Otherwise, the flow proceeds to step S534.

Then, the CPU 41 judges whether an end of the sentence for which the first flick operation is performed has been passed on the liquid crystal display 8 during the first scrolling process in the predetermined direction for the part of the contents displayed on the liquid crystal display 8 (step S534).

When judging the end of the sentence for which the first flick operation is performed has been passed on the liquid crystal display 8, the CPU 41 executes a process that displays a next sentence from the beginning for one block (step S532). Otherwise, the flow proceeds to step S535.

Further, the CPU 41 executes the first scroll process which scrolls the part of the contents in response to the first flick operation in the predetermined direction for one block (step S535), the flow proceeds to step S 540 described in FIG. 8.

In the foregoing embodiment, a description has been given using the liquid crystal display 8 displaying two lines of sentences in the documents.

However, the present invention is not limited to this but can equally be applied to the liquid crystal display 8 which displays less or more than two lines.

In the foregoing embodiment, a description has been given using the electronic apparatus 1 executing the above processes when detecting the flick operation on the liquid crystal display with touch panel 80.

However, the present invention is not limited to this but can equally be applied to the electronic apparatus 1 which executes the above processes when detecting when detecting a predetermined operation such as drag operation, swipe operation and touch panel operation operated by plural finger.

As explained above, in the foregoing embodiment, the electronic apparatus 1 comprises the liquid crystal display with touch panel 80 which includes the liquid crystal display 8 displaying contents and the touch panel 43 of the inputting section 45 outputting signals corresponding to touch positions of the operation object 90 and the CPU 41 which detects the first flick operation of the operation object 90 based on an alteration of the signals corresponding to the touch position on the operation interface of the touch panel 43 from moment to moment.

Then, when detecting the first flick operation in the predetermined direction which is a direction from right to left, the CPU 41 executes the first scrolling process which scrolls the part of the contents displayed on the liquid crystal display 8 in the predetermined direction for the first moving amount which is an equal to or smaller amount than a horizontal width of the liquid crystal display 8.

When the second flick operation in the backward direction against the predetermined direction is detected during the above first scrolling process for one block or a predetermined time after stopping the above first scrolling process, the CPU 41 executes the second scrolling process which scrolls the part of the contents displayed on the liquid crystal display 8 in the backward direction from right to left for the second moving amount which is smaller amount than the first moving amount.

In this way, the electronic apparatus 1 and a method and the program 51p thereof, which can easily display his/her intended part of the contents for the user in state that a part of the contents is displayed on the liquid crystal display 8, can be provided.

Namely, a conventional scrolling process corresponding to a flick operation has a problem which users can not find easily their intended part of contents because the scrolling process is executed with high speed.

In the foregoing embodiment as described above, however, the user can easily find his/her intended part of the contents by displaying various parts of the contents in response to the second flick operation because the second moving amount to be scrolled is adjusted to an smaller amount than the first moving amount when the second flick operation in the backward direction against the predetermined direction is detected during the first scrolling process for one block in the predetermined direction or a predetermined time after stopping the first scrolling process.

In this way, the electronic apparatus 1 and a method and the program 51p thereof, which can easily display his/her intended part of the contents for the user, can be provided by simple touch panel operations.

In the foregoing embodiment, the CPU 41 can executes the second scrolling process definitely from right to left for the second moving amount without the interrupting process because the CPU 41 does not detect any flick operations by the flick operation detecting section 411 during the second scrolling process from right to left direction for the second moving amount.

In the foregoing embodiment, simple constitutions of the electronic apparatus 1 can be required in order to execute above processes corresponding to the flick operation by comprising the flick operation direction storing section 521 and the flick number storing section 522.

Further, in the foregoing embodiment, the CPU 41 can executes the second scrolling processes corresponding the second flick operation definitely by resetting the flick number stored in the flick number storing section 522 at step S950.

Further, in the foregoing embodiment, the electronic apparatus 1 and a method and the program 51p thereof, which can easily display his/her intended part of the contents for the user, can be provided by adjusting the second moving amount for the second scrolling process corresponding to the second flick operation and timing which the second flick operation is performed, as described above.

Further, in the foregoing embodiment, the electronic apparatus 1 and a method and the program 51p thereof, which can easily change a display area of the contents on the liquid crystal display 8 and display his/her intended part of the contents for the user, can be provided by scrolling the part of the contents for the first moving amount when the further first scrolling operation is detected after scrolling the part of the contents for the second moving amount in response to the second scrolling process.

Further, in the foregoing embodiment, the electronic apparatus 1 and a method and the program 51p thereof, which can easily display his/her intended part of the contents for the user, can be provided by displaying a next sentence from the beginning when the flick operation performed in horizontal direction from an end to beginning of a displayed sentence is detected while the part of the contents included a break line code or end of the displayed sentence is displayed on the liquid crystal display 8.

Further, in the foregoing embodiment, the user can easily find his/her intended part of the contents because the CPU 41 executes following processes repeatedly that scroll the part of the contents for a predetermined time such as 0.2 seconds corresponding the flick operation, then stop and fix the scrolling process for a predetermined time such as 0.8 seconds.

Further, in the foregoing embodiment, the electronic apparatus 1 and a method and the program 51p thereof, which can easily display his/her intended part of the contents which includes pictures for the user, can be also provided.

### Second Embodiment

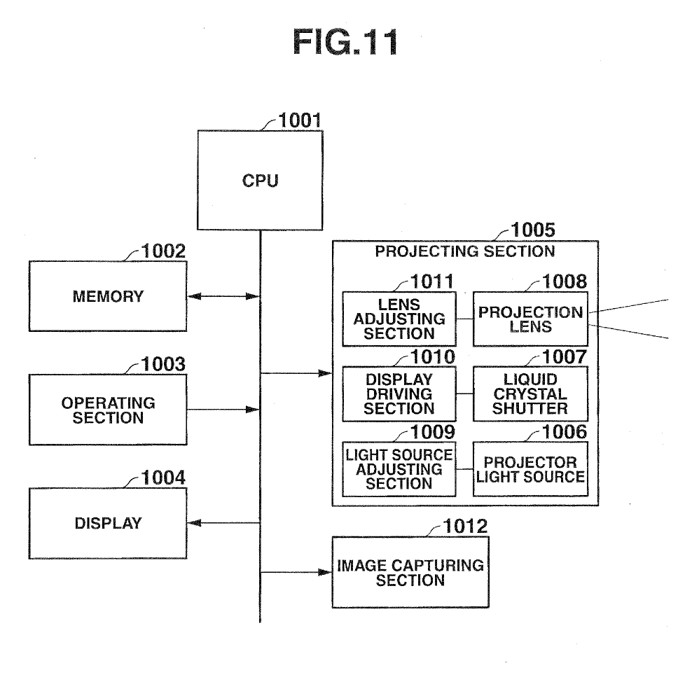

Hereinafter, second embodiment of the invention will be described by reference to FIG. 11-FIG. 14.

In this second embodiment, a description will be provided by using a projector which can convert image data to light and project it instead of the electronic apparatus 1 described in above first embodiment.

FIG. 11 is a functional block diagram of the projector applied as the electronic apparatus according to the embodiment of the invention.

The projector has a projecting function which projects a projection object on a screen, an image capturing function which captures user's gesture (especially hand gesture) and a scrolling function which executes a scrolling process based on a detection result of the captured gesture captured by the image capturing function.

The projection object may comprise images, graphs, charts and sentences used as presentation documents.

And, in the scrolling function of this second embodiment, the projection object which is projected on the screen is controlled so as to be scroll on the screen.

For example, when all of the projection object can not be projected on the screen, the projector scrolls a part of the projection object which is currently displayed on the screen in a predetermined direction corresponding to the detected user's gesture.

A CPU 1001 is a central processing unit which controls all performances of the projector in accordance with various programs stored in a memory 1002.

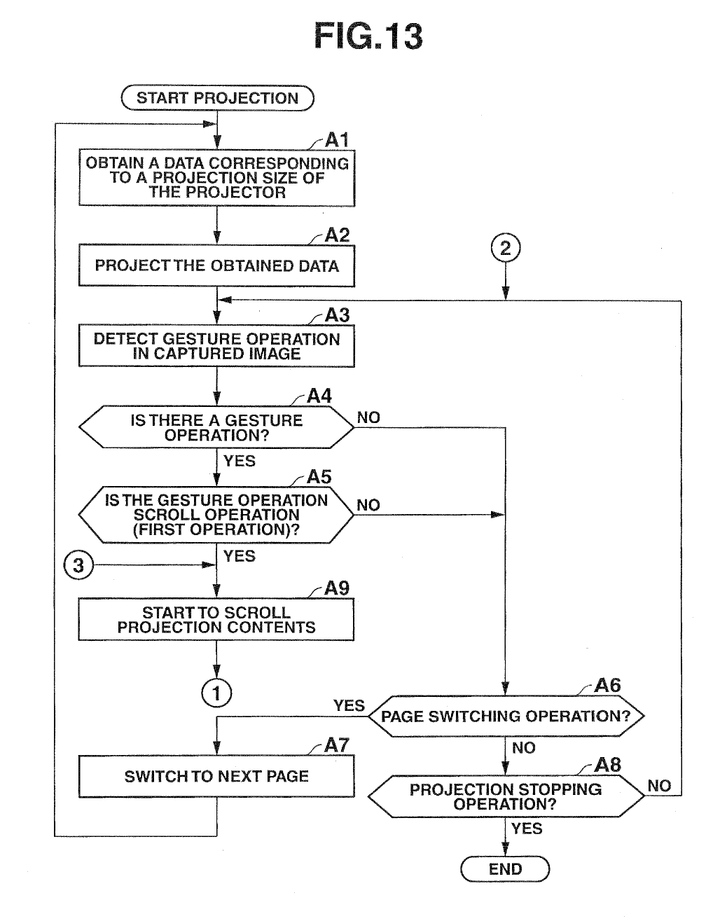

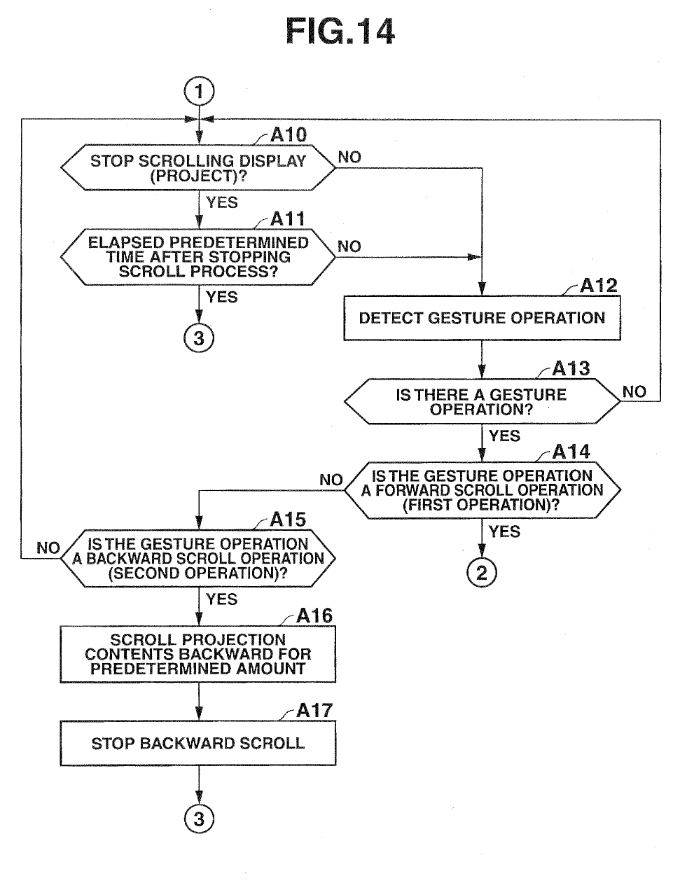

The memory 1002 comprises a program area which stores a program for realizing the embodiment of the invention in accordance with a process described in FIG. 13 and FIG. 14, a data area which stores the projection object such as presentation documents and a work area which stores temporarily various types of information (i.e. flag etc.) required for working the projector.

And, the memory 1002 may be comprised so as to include a removable and transportable memory such as SD card and IC card. The memory 1002 may also be comprised a memory area in a predetermined server only in state of a connection to a network via a communication function.

The operating section 1003 comprises a power on/off switch key used to switch on and off a power supply as a push button.

The display 1004 may be a high definition liquid crystal display.

A projecting section 1005 comprises a projector light source 1006, a liquid crystal shutter 1007 generating images of the projection object, a projection lens 1008, a light source adjusting section 1009 adjusting a brightness and on/off of the projector light source 1006 by controlling thereof, a display driving section 1010 driving the liquid crystal shutter 1007, and a lens adjusting section 1011 adjusting focus and zoom by controlling the projection lens 1008.

An image capturing section 1012 is a digital still camera which captures user's gesture.

The image capturing section 1012 can capture a high definition image by forming the image on an imaging element such as CCD and CMOS, and perform continuous shooting process with a predetermined frame rate such as 15 fps.

And, it can prevent that user's hand comes in a project area on the screen by separating the image capturing section 1012 and the projecting section 1005 by a distance.

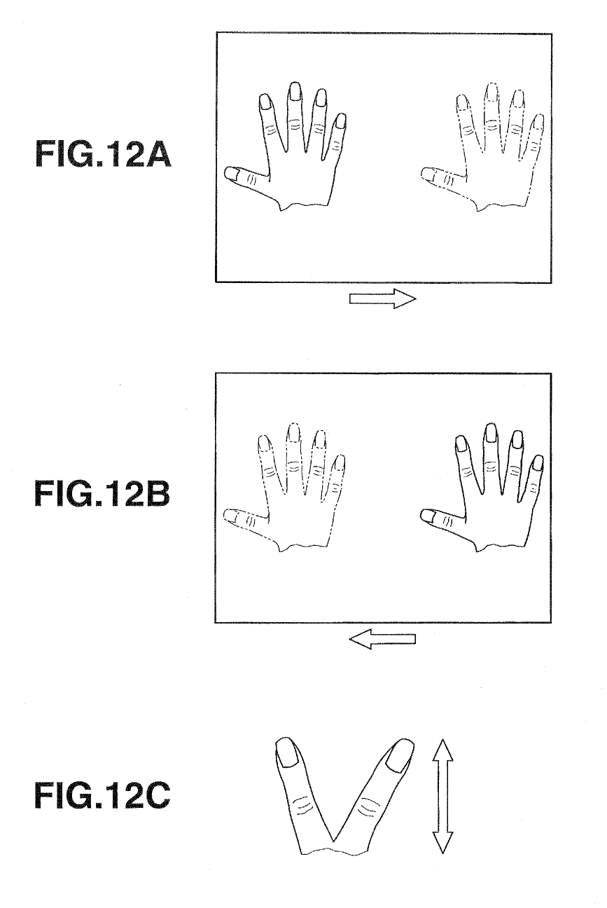

FIGS. 12A-12C is an explanatory diagram showing a gesture operation performed in front of the image capturing section 1012.

FIG. 12A indicates a state of user's gesture as a first operation that the user moves his/her hand from left to right (direction of arrow) while opening his/her hand keeps facing to the screen.

The CPU 1001 recognizes a gesture operation performed by the user as the first operation that instructs a scrolling process and a scrolling direction corresponding to the first operation by analyzing an image captured by the image capturing section 1012.

The continuous scrolling process is one of following processes, a process scrolls the projection object for a predetermined time such as one second after the gesture operation, a process scrolls the projection object in response to a moving amount and/or speed of the gesture operation, and a process keeps scrolling the projection object until the continuous scrolling process is interrupted.

In the process that scrolls the projection object in response to a moving amount and/or speed of the gesture operation, the more the moving amount and/or speed increase, the more a scrolling time corresponding to the gesture operation gets longer.

FIG. 12A indicates the first operation instructing the continuous scrolling process and the scrolling direction corresponding to the first operation.

FIG. 12B indicates a state of user's gesture as a second operation that the user moves his/her hand from right to left (direction of arrow) while opening his/her hand keeps facing to the screen.

The CPU 1001 detects the second operation performed after detecting the first operation that controls the continuous scrolling process by analyzing the captured image.

In this case, the CPU 1001 detects the second operation performed in a backward direction against the first operation during the continuous scrolling process corresponding to the first operation or a predetermined time such as 2 seconds after stopping the continuous scrolling process.

FIG. 12B indicates such like the second operation.

In this way, the CPU 1001 executes a backward scrolling process that scrolls the projection object in a backward direction against the first operation for a predetermined moving amount and stops the backward scrolling process, when detecting the second operation after detecting the first operation.

In this case, the backward scrolling process is performed in the backward direction which is a direction from right to left.

The CPU 1001 keeps stopping the backward scrolling process after processing the backward scrolling process corresponding to the second operation until next first operation is detected.

In this embodiment, the gesture operation is not limited to the gesture which the opening user's hand moves in horizontal direction but a gesture which the opening user's hand moves in vertical direction or a user's hand forming peace sign moves in horizontal or vertical directions described in FIG. 12C. FIG. 12C especially indicates that the user's hand forming peace sign moves in vertical direction.

Hereinafter, a performance concept of the projector in the second embodiment will be described by reference to FIG. 13 and FIG. 14.

Each function described in this flow chart is stored as readable program codes, and performances corresponding to the readable program codes are performed as needed.

The readable program codes may be obtained from a server via a network.

FIG. 13 and FIG. 14 are flowcharts showing a flow of a scrolling process performed by the projector. And FIG. 13 and FIG. 14 are started when a projection process is instructed by the user's operation.

First, the CPU 1001 acquires projection data for a projection size of the projector form full size data for 1 page stored in the memory 1002 as the projection object such as a presentation documents (step A1 described in FIG. 13). The projection size corresponds to a size of the liquid crystal shutter 1007 provided in projecting section 1005.

The CPU 1001 executes a projection process which projects the projection data via the liquid crystal shutter 1007 on the screen such as a whiteboard (step A2). In this state, the CPU 1001 detects user's gesture operation by analyzing the captured image while the captured images are obtained sequentially every one frame from the image capturing section 1012 (step A3) and judges whether the gesture operation is detected (step A4).

When detecting the gesture operation (step A4/YES), the CPU 1001 judges whether the detected gesture operation is the first operation instructing the continuous scrolling process (step A5). For details, the CPU 1001 defines the detected gesture operation by comparing this detected gesture operation and a pre-stored gesture operation.

Further, when the gesture operation is not detected (step A4/NO) or the detected gesture operation is not the first operation instructing the continuous scrolling process (step A5/NO), the CPU 1001 judges whether a page switching operation is performed (step A6) and a projection stopping operation instructing end of the projection process is performed (step A8).

When the page switching operation is performed (step A6/YES), the CPU 1001 proceeds back to step A1 after performing the page switching operation designating next page as projection object in response to such operation (step A7).

When the projection stopping operation is performed (step A8/YES), the flow is out from FIG. 13 and FIG. 14.

Then, when the first operation is detected (step A5/YES), the CPU 1001 detects a moving direction of the first operation as a scrolling direction corresponding to the continuous scrolling process and starts the continuous scrolling process which scrolls and projects the projection object in the scrolling direction on the screen (step A9).

Next, the CPU 1001 judges whether the continuous scrolling process is stopped (step A10 described in FIG. 14).

The CPU 1001 also judges whether a predetermined time such as 2 seconds has been passed after stopping the continuous scrolling process by referring to a timer (not shown in Figs) measuring time after stopping the continuous scrolling process (step A11).

When the predetermined time has been passed after stopping the continuous scrolling process (step A11/YES), the flow returns to step A3 on FIG. 13.

When the continuous scrolling process is not stopped (step A10/NO) or within the predetermined time after stopping the continuous scrolling process (step A11/NO), the flow proceeds to step A12 and the CPU 1001 detects the further gesture operation to be the second operation by analyzing the captured image while the captured images are obtained sequentially every one frame from the image capturing section 1012.

When the continuous scrolling process is not stopped (step A10/NO) or within the predetermined time after stopping the continuous scrolling process (steps A11/NO), the CPU 1001 judges whether the further gesture operation is detected (step A13).

When the further gesture operation is not detected (step A13/NO), the flow returns to step A10.

When the gesture operation is detected (step A13/YES), the CPU 1001 judges whether the detected gesture operation is the first operation instructing the continuous scrolling process (step A14) or the second operation instructing the backward scrolling process (step A15).

When the further first operation is performed (step A14/YES), the flow proceeds to step A9 on FIG. 13 and the CPU 1001 starts the continuous scrolling process again.

When the second operation instructing the backward scrolling process is performed during the continuous scrolling process (step A10/NO) or the predetermined time after stopping the continuous scrolling process (steps A11/NO), the CPU 1001 executes the backward scrolling process in the backward direction against the first operation for a predetermined moving amount (step A16).

The predetermined moving amount of the backward scrolling process corresponding to the second operation is a selectable amount by the user such as the projection size of the liquid crystal shutter 1007 or a smaller size than the projection size.

The CPU 1001 executes a process that stops the backward scrolling process (step A17) and the flow returns to step A3 on FIG. 13

As described above, in the foregoing second embodiment, when detecting the first operation during displaying the projection object, the CPU 1001 executes the continuous scrolling process in a predetermined direction instructed by the first operation.

Following this, when detecting the second operation for controlling the continuous scrolling process after detecting the first operation, the CPU 1001 executes the backward scrolling process instructed by the second operation in the backward direction against the predetermined direction for the predetermined moving amount and stops the backward scrolling process.

As a result, the user can easily find his/her intended part of the projection object during the continuous scrolling process. Namely, an operation performance of the projector during the continuous scrolling process improves.

The first operation and the second operation can be associated with each other by detecting the second operation always after detecting the first operation.

And, the user can easily find his/her intended part of the projection object during the continuous scrolling process because the second operation is performed in different direction from the first operation.

Further, the user can easily find his/her intended part of the projection object during the continuous scrolling process because the backward scrolling process corresponding to the second operation has the smaller moving amount than the first moving amount.

The user can easily make the projector recognized his/her gesture operation because the captured image by the image capturing section 1012 is analyzed sequentially.

And, in the second embodiment described above, a gesture direction of the second operation is not limited to the backward direction in horizontal direction but vertical direction.

In the second embodiment described above, the gesture operations are detected by using the image capturing section 1012 but not limited to this. For example, the gesture operations can be detected as a touch operation operated on the display 1004 by comprising the display 1004 as a touch panel display.

The description, in the second embodiment described above, is an example where the present invention is applied to a projector. However, the present invention can equally be applied to, for instance, a smart phone, other mobile phone, game machine, a music player, a personal computer, a digital camera and a PDA (personal digital assistant).

### Third Embodiment

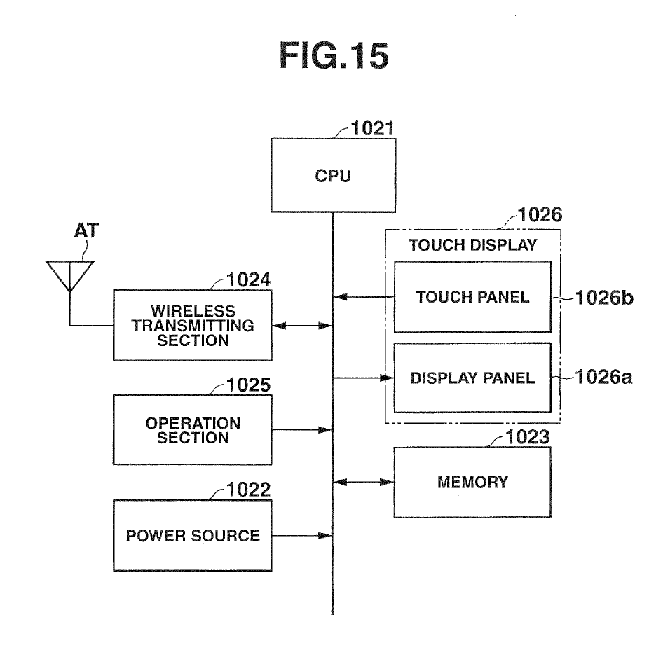

Hereinafter, third embodiment of the invention will be described by reference to FIG. 15-FIG. 17.

In this second embodiment, a description will be provided by using a smartphone instead of the electronic apparatus 1 described in above first embodiment.

FIG. 15 is a functional block diagram of the smartphone applied as the electronic apparatus according to the embodiment of the invention.

The smartphone has a calling function, a touch inputting function, an e-mail function, a web access function, a slide show function and so on. A CPU 1021 operates by power supply from a power source 1022 and controls all performances of the smartphone in accordance with various programs stored in a memory 1023.

The memory 1023 comprises basically a program area, a data area and a work area, but may also comprise a removable and transportable memory such as SD card and IC card as well as the second embodiment.

A wireless transmitting section1024 comprises a RF (radio frequency) circuit, a modulator-demodulator, baseband processing circuit and so on. When the calling function, e-mail function, and web access function are operated, the wireless transmitting section1024 transmits modulated radio waves of data from an antenna AT and receives and demodulates radio waves of data via the antenna AT in order to realize phone call or data communication.

The operating section 1025 comprises various keys such as a power on/off switch key used to switch on and off a power supply as a push button.

The touch display 1026 comprises a display panel 1026a and a touch panel 1026b laminated on the display panel 1026a.

The display panel 1026a may be a high definition liquid crystal display having a predetermined aspect ratio or an organic EL display.

The touch panel 1026b having an operation interface is a sensor which detects a state that an operation object such as finger touches on the operation interface of the touch panel 1026b and a touch position of that operation object and outputs corresponding signals of the touch position. The touch panel 1026b uses such as capacitance type or resistive type touch panel.

On the touch display 1026, the slide show is performed which reads and switches a displayed image which is selected by the user sequentially among images stored in the memory 1023. At this slide show, the displayed images may be switched every predetermined time automatically or by a flick operation operated on the touch display 1026.

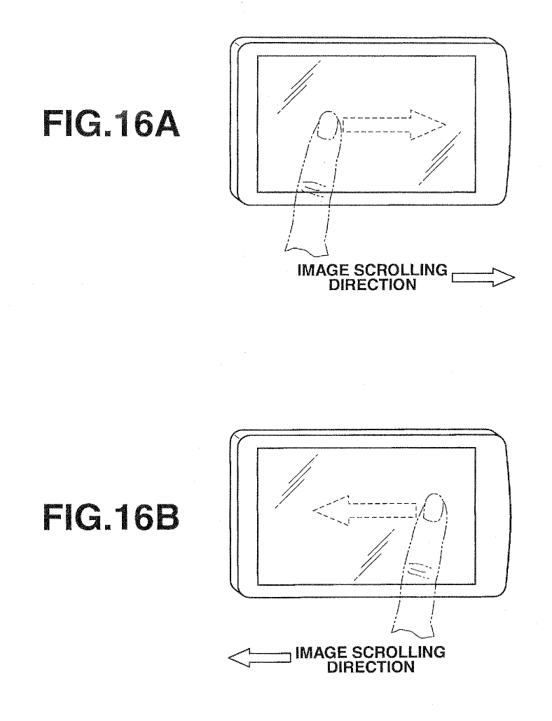

FIGS. 16A-16B are explanatory diagrams showing directions of a flick manipulation on the touch display 1026 and an image switching process during the slide show.

FIG. 16A indicates a state of a flick operation as a first operation that the user moves his/her finger from left to right (direction of arrow) while his/her finger keeps touching on the touch display 1026. In this case, an image switching direction corresponding to the first operation is from right to left.

The CPU 1021 detects the first flick operation operated on the touch display 1026 instructing a first switching process and such moving direction as a first switching direction.

FIG. 16B indicates a state of a backward flick operation as a second operation that the user moves his/her finger from right to left (direction of arrow) while his/her finger keeps touching on the touch display 1026. In this case, a second switching direction corresponding to the second operation is from left to right.

In this way, when detecting the second operation after detecting the first operation, the CPU 1021 executes a second switching process that switches the displayed images as a display object from left to right for a predetermined moving amount and stops the second switching process.

In this second switching process, the display object is switched to the last image as the predetermined moving amount.

The CPU 1021 keeps stopping the second switching process after processing the second switching process corresponding to detecting the second operation until next operation is detected.

The flick operation is not limited to an operation which the user moves his/her finger in horizontal direction but an operation which the user moves his/her finger in vertical direction. In this case, the image switching direction is in vertical direction also.

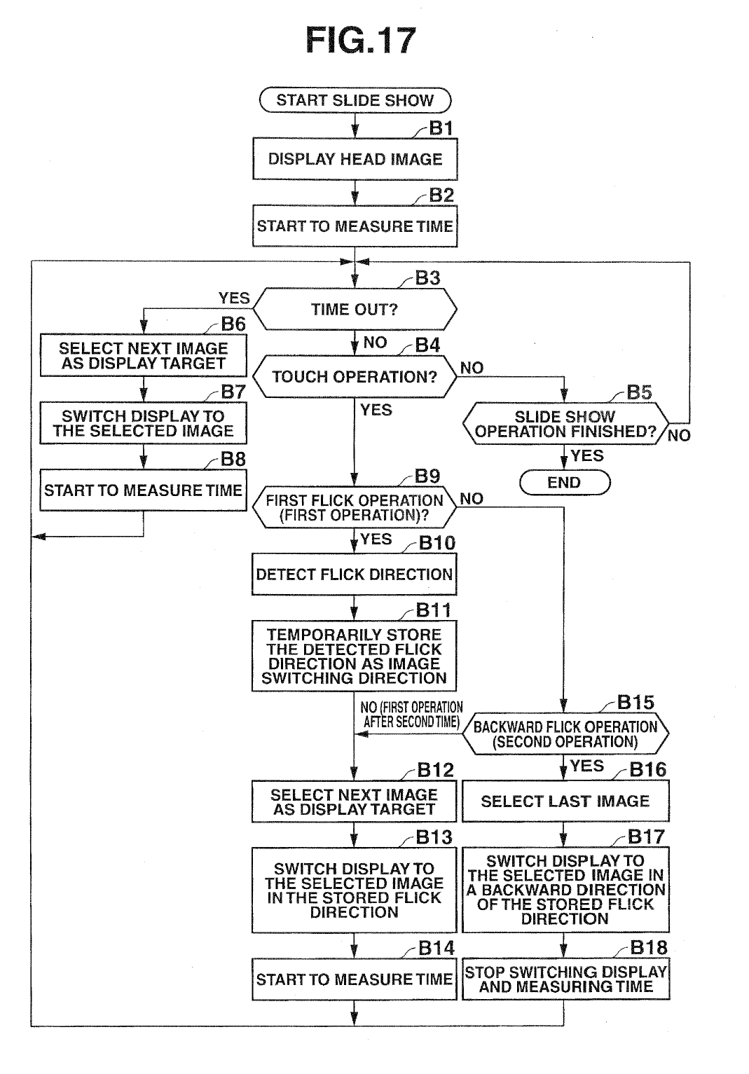

FIG. 17 is a flowchart showing the flow of a switching process performed by the smartphone.

First, the CPU 1021 reads and displays the display object stored in memory 1002 (step B1) and makes a timer, which is not shown in Figs, start to measure time (step B2). In this state, the CPU 1021 judges whether a predetermined image switching time such as 5 seconds has been passed (step B3), a touch operation is operated on the touch display 1026 (step B4), and an operation instructing end of the slide show is performed (step B5).

When the operation instructing end of the slide show is performed (step B5/YES), the flow is out from FIG. 17.

When the predetermined image switching time such as 5 seconds has been passed (step B3/YES), the CPU 1021 selects next image as the display object (step B6) and switches the display object to the selected next image on the touch display 1026 (step B7). Then, the flow returns to step B3 described above after activating the timer (step B8).

The slide show performs by repeating these processes described above.

Further, when a touch operation is performed on the touch display 1026 during the slide show (step B4/YES), the CPU 1021 judges whether the touch operation is a flick operation as the first operation (step B9).

When the touch operation is the first operation (step B9/YES), the CPU 1021 detects a moving direction of the first operation (step B10) and memories the moving direction of the first operation as the first switching direction in the memory 1023 (step B11).

And, the CPU 1021 switches the display object to the selected image corresponding to the first operation (step B13) after selecting next image corresponding to the first switching direction as the display object (step B12).

Further, the CPU 1021 makes the timer reset and restart to measure time (step B14), the flow returns to step B3.

On the other hand, when the touch operation is not the first operation (step B9/NO), the CPU 1021 judges whether the touch operation is the second operation operated in a backward direction against the moving direction of the first operation (step B15).

When the touch operation is not the second operation but the further first operation (step B15/NO), the CPU 1021 performs the first switching process again described in above corresponding to this first operation.

When the touch operation is the second operation (step B15/YES), the CPU 1021 selects last image as the display object (step B16) and switches the display object backward to the selected last image (step B17).

Then, the flow returns to step B3 after stopping the timer and the backward image switching process (step B18).

Incidentally, in step B16 and B17, the CPU 1021 may switch the display object backward for a predetermined amount such as an amount of two images.

As described above, in the third embodiment, when detecting the first operation during the slide show, the smartphone switches the display object in the first switching direction corresponding to the first operation. When detecting the second operation for controlling the first switching process after detecting the first operation, the CPU 1021 switches the display object to the last image and stops this second switching process. As a result, the user can easily find his/her intended part in the display object even if his/her intended part has been passed on the touch display 1026 during the first switching process. Namely, an operation performance of the smartphone during the slide show improves.

The user can easily find his/her intended part in the display object by performing the second operation because, in the second operation, the second switching direction is a backward direction against the moving operation of the first operation.

The user can easily find his/her intended part in the display object by switching it in the backward switching direction against the moving direction of the first operation because the CPU 1021 stores the moving direction temporarily when performing the first operation.

An operation performance of the smartphone during the slide show improves because the second operation operated on the touch display 1026 is detected after detecting the first operation.

Incidentally, in this third embodiment, the smartphone may detect the first and second operation as user's gesture by analyzing an image captured by a camera function which is not shown in Figs as well as the second embodiment.

In the third embodiment described above, the moving direction of the second operation is not limited to a backward direction against the first operation but vertical direction, for example.

The description, in the third embodiment described above, is an example where the present invention is applied to a smart phone. However, the present invention can equally be applied to, for instance, a projector, other mobile phone, game machine, a music player, a personal computer, a digital camera and a PDA (personal digital assistant).

For example, even when some of the constituent elements of the configurations of the embodiments described above are omitted, this modified configuration is included in the present invention as long as the same effect can be obtained.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An electronic apparatus for scrolling contents, comprising:
a first operation detecting section for detecting a first operation instructing a first scrolling process of the contents for a first amount;
a scrolling section for scrolling the contents in a scrolling direction instructed by the first operation;
a second operation detecting section for detecting a second operation instructing a second scrolling process which controls the first scrolling process instructed by the first operation after detecting the first operation; and
a scroll controlling section for scrolling the contents backward against the scrolling direction for a second amount which is preset as a different amount from the first amount when the second operation is detected by the second operation detecting section.

2. An electronic apparatus according to claim 1,
wherein the second operation detecting section detects an operation as the second operation performed (1) during the first scrolling process instructed by the first operation or (2) within a predetermined time after detecting the first operation.

3. An electronic apparatus according to claim 1,
wherein the second operation comprises an operation performed in a different direction from the first operation.

4. An electronic apparatus according to claim 1,
wherein the second amount is equal to or smaller than an amount corresponding to a display size in the scrolling direction.

5. An electronic apparatus according to claim 1, further comprising:
an image capturing section;
wherein the first operation detecting section detects a user's gesture based on an image captured by the capturing section as the first operation, and
wherein the second operation detecting section detects a user's gesture based on an image captured by the capturing section as the second operation.

6. An electronic apparatus according to claim 1, further comprising:
a touch display section comprising a display which displays the contents and a touch panel;
wherein the first operation detecting section detects a flick operation performed on the touch display section as the first operation, and
wherein the second operation detecting section detects a flick operation performed after detecting the first operation on the touch display section as the second operation.

7. An electronic apparatus for switching and displaying contents sequentially every predetermined time, comprising:
a first operation detecting section for detecting a first operation instructing a first switching process of the contents in a switching direction instructed by the first operation;
a second operation detecting section for detecting a second operation which controls the first switching process instructed by the first operation after detecting the first operation; and
a switch controlling section for switching the contents backward against the switching direction for a predetermined amount which is preset as a different amount from an amount switched by the first switching process when the second operation is detected by the second operation detecting section.

8. An electronic apparatus according to claim 7,
wherein the second operation comprises an operation performed in a different direction from the first operation, and
wherein the switch controlling section switches the contents to a last content.

9. An electronic apparatus according to claim 8, further comprising:
a storing section for temporarily storing the switching direction of the first switching process instructed by the first operation, and
wherein the switch controlling section switches the contents in a backward direction against the stored switching direction.

10. An electronic apparatus according to claim 7, further comprising:
a touch display section comprising a display which displays the contents and a touch panel;
wherein the first operation detecting section detects a flick operation performed on the touch display section as the first operation, and
wherein the second operation detecting section detects a flick operation performed after detecting the first operation on the touch display section as the second operation.

11. An electronic apparatus according to claim 7, further comprising:
an image capturing section;
wherein the first operation detecting section detects a user's gesture based on an image captured by the capturing section as the first operation, and
wherein the second operation detecting section detects a user's gesture based on an image captured by the capturing section as the second operation.

12. A non-transitory computer-readable recording medium with an executable contents scrolling program stored thereon, wherein the contents scrolling program instructs a computer of an electronic apparatus which scrolls the contents to perform the following steps:
detecting a first operation instructing a first scrolling process of the contents for a first amount;
scrolling the contents in a scrolling direction instructed by the first operation;
detecting a second operation instructing a second scrolling process which controls the first scrolling process instructed by the first operation after detecting the first operation; and
scrolling the contents backward against the scrolling direction for a second amount which is preset as a different amount from the first amount when the second operation is detected by the second operation detecting section.

13. A non-transitory computer-readable recording medium with an executable contents switching program stored thereon, wherein the contents switching program instructs a computer of an electronic apparatus, which switches and displays the contents sequentially every predetermined time, to perform the following steps:
detecting a first operation instructing a first switching process of the contents in a switching direction instructed by the first operation;
detecting a second operation which controls the first switching process instructed by the first operation after detecting the first operation; and
switching the contents backward against the switching direction for a predetermined amount which is preset as a different amount from an amount switched by the first switching process when the second operation is detected by the second operation detecting section.
